(19) United States
(12) Patent Application Publication
(10) Pub. No.: US 2015/0100582 A1
(43) Pub. Date: Apr. 9, 2015

(54) ASSOCIATION OF TOPIC LABELS WITH DIGITAL CONTENT

(71) Applicant: Cisco Technology, Inc., San Jose, CA (US)

(72) Inventors: Yongxin Xi, San Jose, CA (US); Qian Diao, San Jose, CA (US); Venkata Gadde, Santa Clara, CA (US)

(73) Assignee: Cisco Technology, Inc., San Jose, CA (US)

(21) Appl. No.: 14/048,639

(22) Filed: Oct. 8, 2013

(51) Int. Cl. G06F 17/30

(52) U.S. Cl. CPC G06F 17/30705
USPC 707/738

(57) ABSTRACT

In one embodiment, digital content labeling includes receiving digital media content. Content is broken into topically homogenous segments, and these segments are clustered in accordance with segment similarities. A topic label is associated by user assignment or user confirmation with a segment in a cluster, and this topic label is propagated to other segments in the same cluster. A label rank may be associated with a label.

### TECHNICAL FIELD

The present disclosure relates generally to association of topic labels with digital content.

### BACKGROUND

Digital content includes pictures, audio, video, text-based information, or combinations of two or more types. Devices for capturing or generating digital content are becoming extremely capable and less expensive due to continuing improvements in technology. These factors lead to capturing, storing or distribution of mass quantities of digital content in a growing number of areas.

It may be difficult to identify which stored digital content may be of interest in any particular situation, or to a particular user or users.

### BRIEF DESCRIPTION OF THE DRAWINGS

FIG. 1 illustrates an example of system for acquiring, labeling, or distributing of digital content data;

FIG. 2 is a block diagram illustrating an example of a computer system upon which an example embodiment may be implemented;

FIG. 3 illustrates an example of a methodology for acquiring, labeling, or distributing of digital content data;

FIG. 4 illustrates an example of content labeling including content and associated labels;

FIG. 5 illustrates an example of template data associated with a content labeling system;

FIG. 6 illustrates an example of a methodology for determining or applying topic labels; and

FIG. 7 illustrates an example of topic label propagation in topic clusters.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In an example embodiment described herein, there is disclosed a method comprising receiving template data, wherein the template data suitably includes one or more associated topic labels. The method further comprises receiving digital media content, the digital media content data including at least one property associated therewith, and isolating at least one property associated with the received digital media content. The method further comprises comparing the at least one property with the template data and assigning at least one topic label to the at least one property in accordance with the comparison.

In an example embodiment described herein, there is disclosed an apparatus or logic encoded with which an interface is operable to communicate with at least one associated device. The interface is operable to receive template data. The template data suitably includes one or more associated topic labels. The apparatus or logic is further operable to receive digital media content, the digital media content data including at least one property associated therewith. The apparatus or logic is operable to isolate at least one property associated with the received digital media content and to compare the at least one property with the template data. The apparatus or logic is further operable to assign at least one topic label to the at least one property in accordance with the comparison.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Digital content, such as multimedia content, sound content, text content or image content is available via devices that are becoming increasingly more capable and less expensive. Digital content capture devices include video cameras, still cameras, text data inputs, streaming data inputs, audio transducers or scanners. In businesses, content may be associated with meetings, training, seminars, sales calls, teleconferences or productions for publication. Over time, particularly in larger organizations, content may be stored in different locations, and therefore generally inaccessible to those who may benefit by viewing or listening. Even if content were to be stored in a common, readily accessible location, it may be difficult, if not impossible, for a user to locate content, or portions thereof, that may be of particular interest. Labeling of content for future search, retrieval or playback allows for quick and efficient identification of content that may be of interest in a particular situation.

Labeling of content suitably addresses example areas including temporal information, such as time or date of generation, topic or topics covered or a location where content is stored or created. In a business setting, labeling suitably includes identifying products or services that may be associated with content. It will be appreciated that any suitable heading, topic or other identifier is suitably added or associated with content, or a portion thereof, as a label.

Humans are able to review and label content. However, the process is time consuming and expensive. Automated, or semi-automated labeling minimizes or eliminates such concerns.

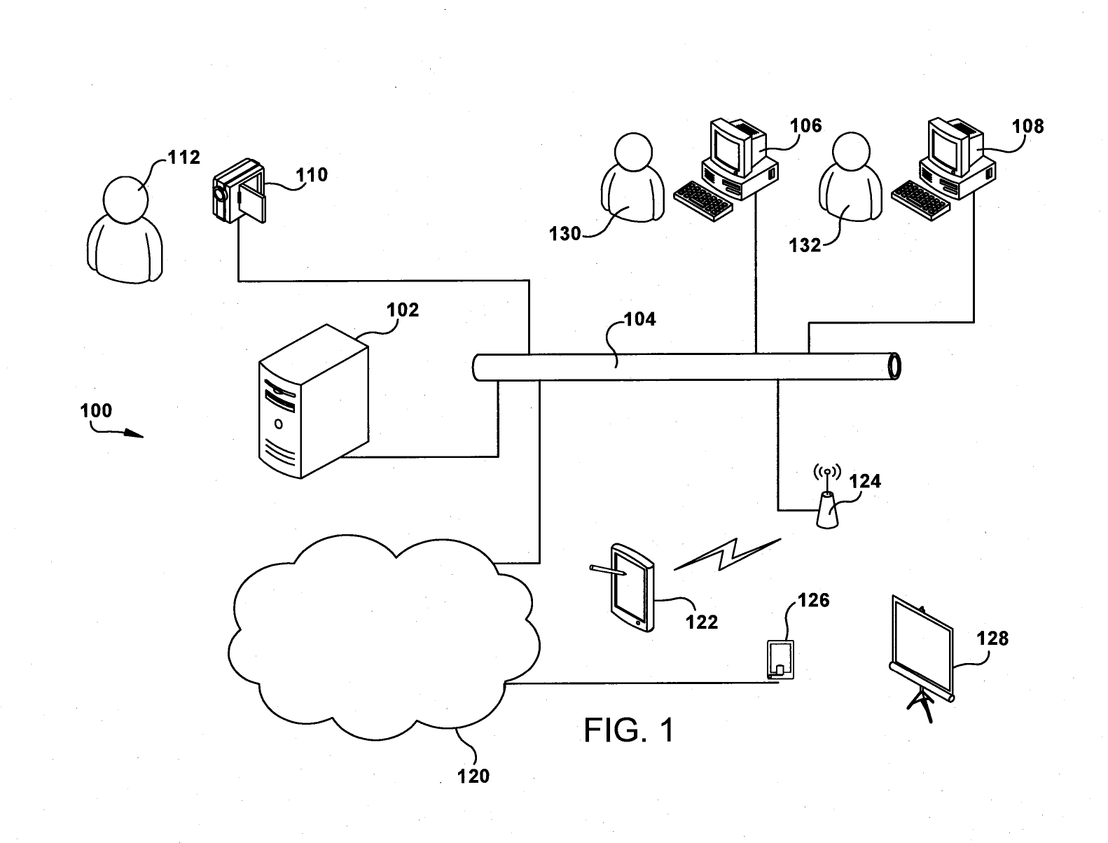

Turning now to FIG. 1, illustrated is an example system 100 for acquiring, storing, labeling, distributing and displaying digital content. The illustrated system includes at least one content server, such as server 102. Multiple or distributed content servers are suitably implemented. Examples of a suitable server platform are detailed further below. Server 102 is suitably in data communication with one or more processing, acquisition or display devices. In an example embodiment, server 102 is in data communication via a network connection 104. Such network connection is illustrated as a wired connection, however it will be appreciated that such network is suitably wireless.

In the illustrated embodiment, server 102 is further in data communication with one or more computers, such as those illustrated at computer 106 and computer 108. Also in communication with the server 102, suitably via network 104, is one or more cameras, such as camera 110. Camera 110 is suitably a motion picture camera with audio capture operable to capture content relative to a speaker or presenter, such as with illustrated speaker 112. Network 104 is also suitably in data communication with a wide area network 120, which includes the Internet in an example embodiment. Interconnection with a wide area network allows for any of the devices to be remotely located. Also illustrated is a portable data device 122 illustrated as in data communication with the network 104 via connection with an access point 124. Also, illustrated is a video playback device, such as projector 126, illustrated in conjunction with a display screen 128. It will be appreciated that the particular data connections illustrated are by way of example only, and that any device may be suitably connected directly, via a local network or via a wide area network, such as the Internet, or connected wirelessly or via a wired connection.

The illustration of FIG. 1 provides an example platform suitable for providing capture, storage, transmission and labeling of digital content. The illustrated embodiment further provides an example platform that facilitates content or label review, label selection or label correction by human users, such as users 130 and 132, or via crowd sourced labeling, as will be understood with the additional teachings below. In the illustrated embodiment, user 130 is associated with computer 106 and user 132 is associated with computer 108, which computers allow for display of content. By way of further example, computers 106 and 108 include multimedia playback capability, and allow for user input relative to labeling of content. It will be appreciated that any suitable digital user device may be used, including tablets, smartphones, portable computers, and the like.

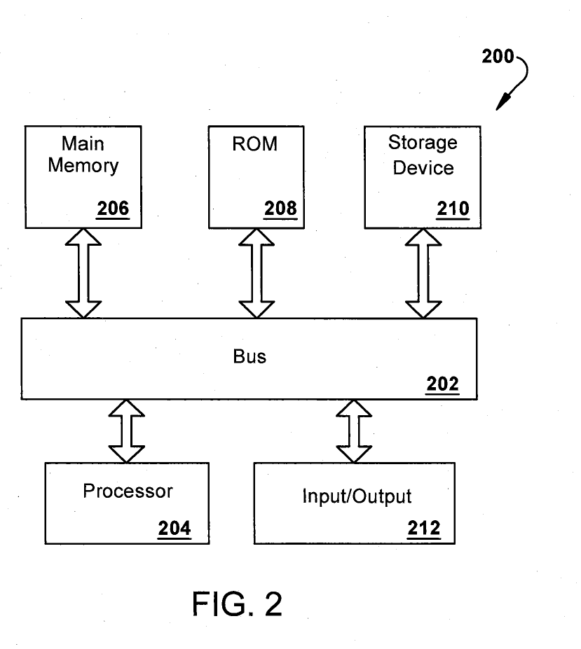

FIG. 2 is a block diagram illustrating an example of a suitable computer system 200, such as that used in connection with server 102. The computer system 200 may be employed to implement the functionality of server 102 of FIG. 1. Computer system 200 includes a bus 202 or other communication mechanism for communicating information and a processor 204 coupled with bus 202 for processing information. Computer system 200 also includes a main memory 206, such as random access memory (RAM) or other dynamic storage device coupled to bus 202 for storing information and instructions to be executed by processor 204. Main memory 206 also may be used for storing temporary variable or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk, optical disk, and/or flash storage, is provided and coupled to bus 202 for storing information and instructions. An input/output unit 212 facilitates communication via keyboard, mouse, network interface, or any other device outside of the system 200. In an example embodiment, computer system 200 is suitably comprised of a Cisco MXE 3500 Media Experience Engine which is particularly suited for use in conjunction with the subject disclosure.

It is to be appreciated that the all or some of the functionality of the server 102 as disclosed herein are suitably accomplished via a computer system, such as that 200, or via discrete logic or hybridized combinational or synchronous logic. “Logic,” as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (“ASIC”), system on a chip (“SoC”), programmable system on a chip (“PSOC”), a programmable/programmed logic device, memory device containing instructions, or the like, or combinational logic embodied in hardware. Logic may also be fully embodied as software stored on a non-transitory, tangible medium which performs a described function when executed by a processor. Logic may suitably comprise one or more modules configured to perform one or more functions.

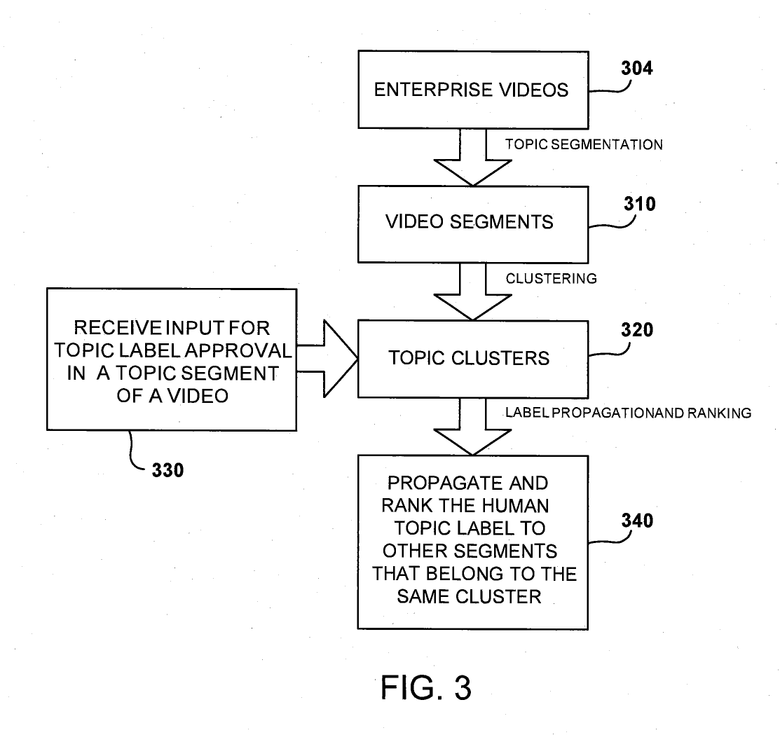

Turning now to FIG. 3, illustrated is embodiment of an example flow diagram for assigning topic labels to digital media content, suitably in accordance with the example hardware platform detailed above. Content is received at 304. In the example, content is shown as enterprise videos, however it will be appreciated that any content noted herein is suitably input. Received content is suitably subjected to topic segmentation so as to result in one or more video segments at 310.

A suitable system for topic label propagation is akin to a semi-supervised learning problem. Therein, a suitable class of machine learning techniques is implemented to make use of a relatively small amount of labeled data to infer labels for a larger amount of unlabeled data. Particularly suited is a cluster assumption in semi-supervised learning so as to result in topic clusters at 320. Clustering seizes upon a property wherein data tends to form discrete clusters. Points in the same cluster are more likely to share a label. Such a label in machine learning commonly refers to class types. (discrete values) so that data in the same cluster are likely from the same class.

Human input relative to new or approved topic labels is received at 330. It will be appreciated that there can be several topic labels for each segment and while some do, not all of them match well with other segments in the same cluster. Therefore before deciding to share a human-supplied topic label to neighbors in a topic cluster, a a check if the label is relevant to them is suitably made. Next, at 340, a propagation and ranking of human topic labels is suitably accomplished for other segments that belong to the same cluster.

In another example embodiment, two or more users are used in connection with association of topic labels with content data, such as users 130 and 132 of FIG. 1. Multiple users facilitate additional checks relative to proper or desirable association. In yet another example embodiment, a sufficient number of users review the content and provide input relative to association of topic labels such that weighting of input facilitates improved association. In one embodiment, a relatively large number of users are used to crowd source content review and labeling. With a sufficiently large number of users, weighting of popular or dominant labels facilitates selection of more accurate or desirable labels to better catalog content for future search or retrieval.

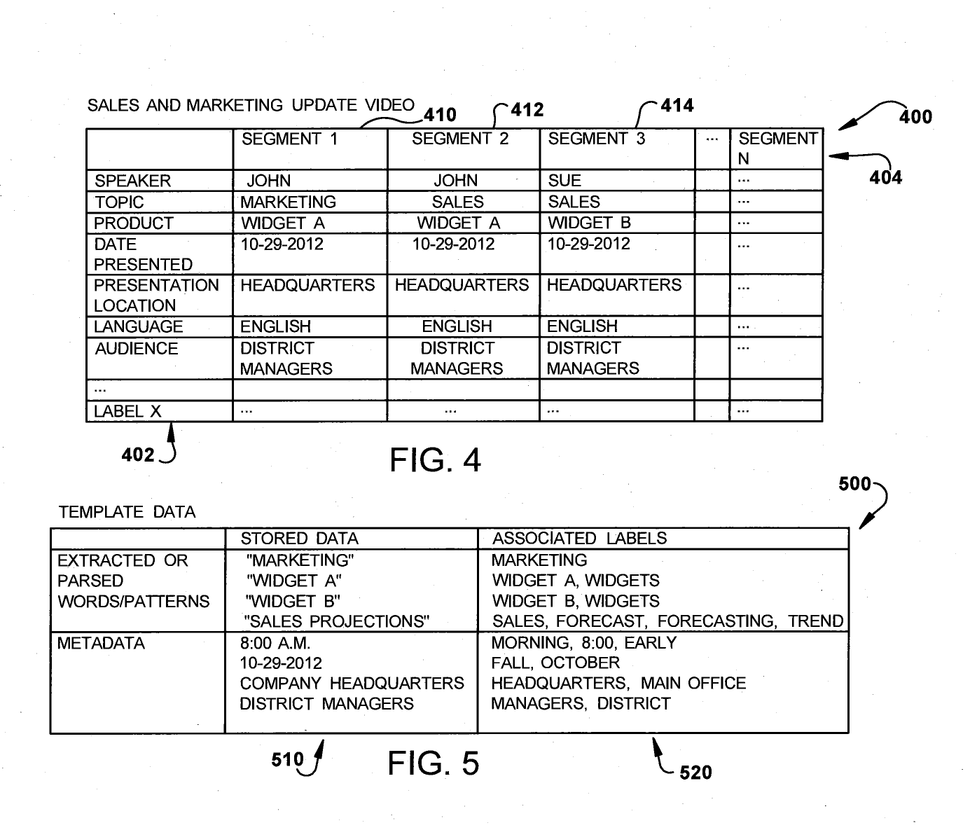

Turning now to FIG. 4, illustrated is an example of received content and associated labeling, which example is a sales and marketing video 400. While the example includes a video, including associated audio, it will be appreciated that content may be audio only, or may include text data, optical data, image data, or any combination thereof. Representative labels 402 are suitably assigned by a human user in a manner such as that detailed above. While several possible labels are listed, it will be appreciated that many different labels will be contemplated in accordance with what may be of interest to a particular user, industry, company, or the like. A particular presentation, such as video 400, may comprise several discernible segments, such as those 404. Segments may be associated with topics, locations, or any other area or demarcation of interest to a particular situation.

In the example of FIG. 4, certain data may be associated with the video 400 in the form of metadata. By way of example, a user reviewing the video may not be aware of the composition of the audience or the date of presentation. Digital files, such as digital multimedia files, audio files or text files, frequently include embedded or associated metadata, or data about the data, relative to acquisition. Metadata is suitably supplied automatically or by a user prior to, during or after generation of content. By way of example, a digital movie camera may generate a file that includes data relative to the time or date of capture, a GPS location for capture, file size, encoding type, and the like. Also, a videographer, editor or other user may add data to a captured event relative to any aspect of the recording. Suitable labels are assignable in accordance with such metadata.

In the illustration of FIG. 4, suitable segmentation and labeling of the video 400 is completed, and the labeling is usable in conjunction with searches. Representative segments 410, 412 and 414 are illustrated. By way of further example, a user could search for all sales presentation information, which would include segments 2 (412) and 3 (414). Alternatively, a user could search for all content directed to district managers, which content would include at least segments 1-3.

FIG. 5 illustrates an example of template data 500 suitably extracted from the video 400. In the example, stored data 510 includes extracted or parsed words and phrases, as well as metadata. Parsing suitably includes breaking down input into discrete portions, such as strings, for further analysis or categorization. It will be appreciated that such words or phrases are suitably stored as digitized speech, or in another embodiment converted to text data via any suitable speech-to-text converter. In the illustration, a stored data item is associated with one or more labels 520. A comparison of such extracted data with the stored data 510 thus facilitates retrieval of corresponding labels for common or similar stored data items.

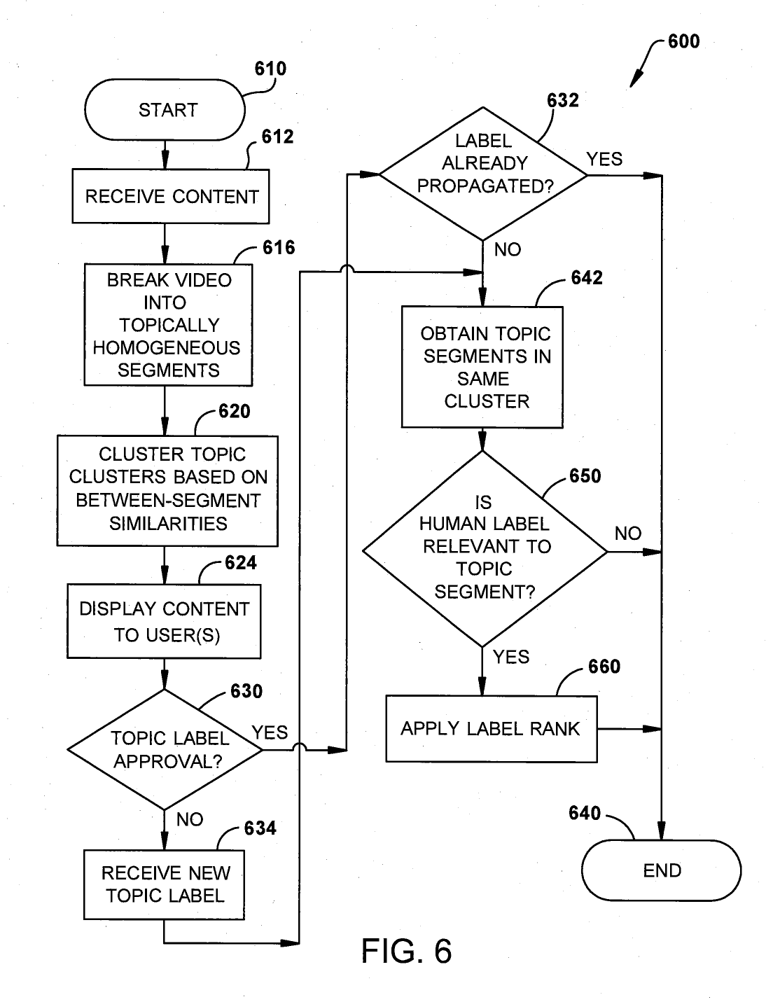

Turning now to FIG. 6, illustrated is a flow diagram of an example operation for content analysis and labeling 600 as noted above. The flowchart commences at 610, and content is received at 612. Next, at 616, video is broken down into topically homogeneous segments by using, for example, an automatic method described above.

Next, at 620, topic clusters are formed based on between-segment similarities. Each topic cluster consists of a group of topic segments that share the same topic. It will be appreciated by one of ordinary skill in the art that there are many approaches to calculate similarity between two text segments. By way of example, one suitable approach is a vector space model. Such an approach suitably uses probabilities of words in each segment as features to represent each video segment as a vector and calculates cosine similarity between two vectors. By way of further example, clustering approaches, such as graph clustering, are suitably applied.

Next, at 624, content is displayed to one or more users. User input suitably provides topic label approval relative to a prior label selection or provision of a new topic label.

At 630, a determination is made as to whether the user input is relative to approval of a prior, assigned topic label. If so, a determination is made at 632 if the associated label was already propagated. If so, the process is completed at 640. If the user input is relative to a new topic labeling, progress proceeds to 634, wherein new topic label assignment is received. In the event that it is determined at 632 that a label was not already propagated, or in the event that a new label has been received, topic segments in a same cluster as an associated, humanly-labeled segment are obtained at 642.

Next, at 650, a determination is made as to whether the human-supplied label is relevant to an associated topic segment. Relevance is suitably determined in a manner such as that detailed above. If the human label is determined to not be relevant, the process suitably ends at 640. If not, a label rank is suitably applied at 660 prior to termination. Rank is suitably based on factors including one or more of relevancy of the topic label to the segment, type of the topic label (human, automatic, propagated), and the like.

For new video content, a periodic analysis is made, wherein initially it is broken into topic segments as noted above. These segments are suitably associated with corresponding topic clusters, or, if new topics are emerging, form a new topic cluster. Then, for each topic cluster that contains new video segment, previously provided human labels are propagated to the new segment in accordance with the forgoing.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

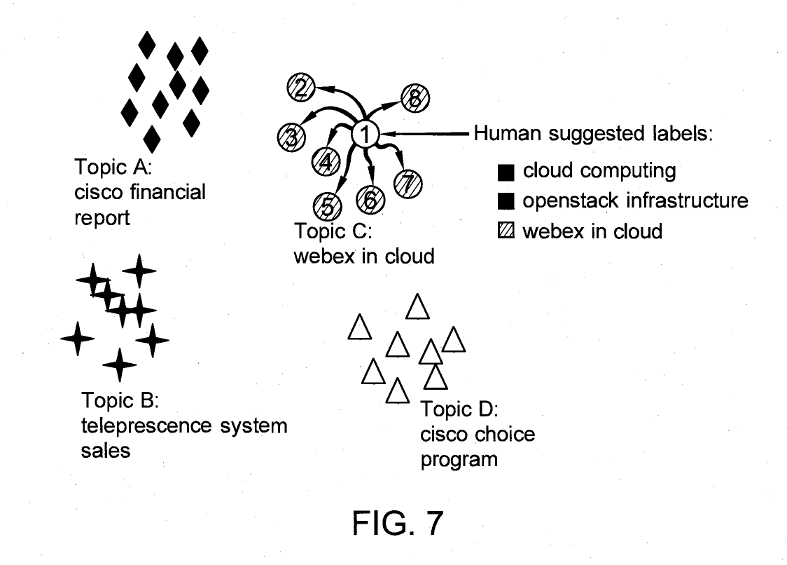

Turning now to FIG. 7, further example of topic label propagation in topic clusters will be made. In the example, there are four topic clusters A, B, C and D. Topic cluster C contains video segments about Cisco Systems' WebExin cloud. A person suggests three topic labels: “cloud computing,” “openstack infrastructure” and “WebEx in cloud” to segment 1 in cluster C. Before sharing the labels with segments 2-8, a check is made relative to relevancy to the segments. In the example, “openstack infrastructure” is only relevant to segment 4, 6 and 7, “cloud computing” is relevant to segment 2, 3 and 5, and “WebEx in cloud” is relevant to all segments. Propagation to relevant segments is then completed. Through propagation, segment 2-7 are automatically labeled 13 times (3 times with “cloud computing,” 3 times with “openstack infrastructure” and 7 times with “WebEx in cloud”), thus alleviating user effort in repeating the labeling process.

Intuitively, label propagation would generally increase the number of topic labels in a segment. Such topic label propagation procedure functions to assure that these topic labels consistently stay ranked. During display, due to not only space constraints but also user experience, it is better to show only a small subset of these labels, such as the top K of the ranked list, 1≦K≦5. Notice that the chosen topic labels should not be mutually redundant. To achieve this, a suitable redundancy removal algorithm, such as MMR, can be applied to reject any lower-rank redundant terms.

1. A method comprising:
receiving digital media content, the digital media content having at least one property associated therewith;
associating topically homogeneous segments from received content in accordance with the at least one property;
generating topic clusters based on similarities between segments;
associating a topic label with a segment in in a topic cluster; and
propagating the topic label to at least one additional segment in common cluster.

2. The method of claim 1 further comprising associating the topic label with the segment in the topic cluster in accordance with input received from an associated human interface.

3. The method of claim 2 wherein the logic is further operable on digital media content further comprised of digital audio data.

4. The method of claim 3 wherein apparatus of claim 1 wherein the logic is further operable on digital media content comprised of digital video data.

5. The method of claim 1 further comprising:
communicating the topic label to an associated user for approval;
receiving approval data from the associated user; and
propagating the topic label in accordance with received approval data.

6. The method of claim 2 wherein the logic is further comprising testing relevance between the topic label associated topic segment.

7. The method of claim 2 wherein the logic is further comprising applying a label rank to the associated topic label.

8. An apparatus comprising:
an interface;
logic coupled with the interface and operable to communicate with at least one associated device;
the logic further operable to receive digital media content, the digital media content having at least one property associated therewith;
the logic further operable to associate topically homogeneous segments from received content in accordance with the at least one property;
the logic further operable to generate topic clusters based on similarities between segments;
the logic further operable to associate a topic label with a segment in in a topic cluster; and
the logic further operable for propagating the topic label to at least one additional segment in common cluster.

9. The apparatus of claim 8 wherein the logic is further operable to associate the topic label with the segment in the topic cluster in accordance with input received from an associated human.

10. The apparatus of claim 9 wherein the logic is further operable on digital media content further comprised of digital audio data.

11. The apparatus of claim 10 wherein apparatus of claim 1 wherein the logic is further operable on digital media content comprised of digital video data

12. The apparatus of claim 8 wherein the logic is further operable to:
communicate the topic label to an associated user for approval;
receive approval data from the associated user; and
propagate the topic label in accordance with received approval data.

13. The apparatus of claim 9 including a server comprising the logic, the server including the interface in data communication with an associated data network.

14. The apparatus of claim 9 wherein the logic is further operable to apply a label rank to the associated topic label.

15. Logic encoded in at least one tangible media for execution and when executed operable to:
receive digital multimedia content;
break received multimedia content into a plurality of generally homogenous segments in accordance with at least one associated property;
generate a plurality topic clusters in accordance with similarities between segments;
receive user topic data from an associated user;
associate a topic label with at least one segment in an associated cluster in accordance with received topic data; and
propagate the topic label for association with at least a second segment in the associated cluster.

16. The logic of claim 15 wherein the logic is further operable to:
communicate data corresponding to a prior assigned topic label to the user; and
confirm relevance of the prior assigned topic label the at least one segment in accordance with the received topic data.

17. The logic of claim 15 further operable to apply a label rank to the topic label.

18. The logic of claim 15 further operable propagate a plurality of topic labels to at least the second segment in the associated cluster.

19. The logic of claim 18 further operable to isolate a subset of topic labels from the plurality of topic labels.

20. The logic of claim 19 further operable to isolate the subset of topic labels by elimination of redundant labels.
